(19) United States
(12) Patent Application Publication
(10) Pub. No.: US 2023/0312376 A1
(43) Pub. Date: Oct. 5, 2023

(54) HYDROGEN PEROXIDE PRODUCTION DEVICE AND USE THEREOF

(71) Applicant: Nanjing University of Science and Technology, Nanjing (CN)

(72) Inventors: Weiqing HAN, Nanjing (CN); Kajia WEI, Nanjing (CN); Kaiqiang SHI, Nanjing (CN); Xiaodong LIU, Nanjing (CN); Xiuyun SUN, Nanjing (CN); Jiansheng LI, Nanjing (CN); Jinyou SHEN, Nanjing (CN)

(21) Appl. No.: 17/837,016

(22) Filed: Jun. 9, 2022

(30) Foreign Application Priority Data
Mar. 31, 2022 (CN) 202210334801.6

(51) Int. Cl. C02F 1/461; C25B 1/30; C25B 11/032; C25B 11/065; C02F 1/467

(52) U.S. Cl. CPC C02F 1/46109; C25B 1/30; C25B 11/032; C25B 11/065; C02F 1/4672; C02F 2001/46171; C02F 2001/46166; C02F 2001/46142; C02F 2305/026; C02F 2305/023; C02F 2301/046; C02F 2201/46135; C02F 2201/4614; C02F 2209/38; C02F 2101/34

(57) ABSTRACT

A gas diffusion electrode includes a carbon fiber tube, a support layer, and a catalyst layer. The carbon fiber tube is straight and functions as a substrate. The support layer includes a carbon black-polytetrafluoroethylene (PTFE) coating, and is disposed on the substrate. The catalyst layer includes carbon black, anhydrous ethanol, and PTFE, and is disposed on the support layer. The gas diffusion electrode has a diameter of 3-20 mm and a length of 50-500 mm.

### CROSS-REFERENCE TO RELAYED APPLICATIONS

Pursuant to 35 U.S.C. § 119 and the Paris Convention Treaty, this application claims foreign priority to Chinese Patent Application No. 202210334801.6 filed Mar. 31, 2022, the contents of which, including any intervening amendments thereto, are incorporated herein by reference. Inquiries from the public to applicants or assignees concerning this document or the related applications should be directed to: Matthias Scholl P. C., Attn.: Dr. Matthias Scholl Esq., 245 First Street, 18th Floor, Cambridge, MA 02142.

### BACKGROUND

The disclosure relates to the field of wastewater treatment, and more particularly, to a gas diffusion electrode, a hydrogen peroxide production device comprising the gas diffusion electrode and use thereof.

Conventionally, hydrogen peroxide (H₂O₂) is manufactured by a process which includes preparing a working solution including alkyl anthraquinone and an organic solvent; introducing hydrogen into the working solution in the presence of a catalyst at 0.3 MPa and 55° C.-65° C.; introducing air (or oxygen) that flows in an opposite direction to the hydrogen into the working solution at 40° C.-44° C.; and extracting, regenerating, refining, and concentrating the working solution to obtain a solution containing hydrogen peroxide the mass fraction of which is 20%-30%. The anthraquinone process is tedious and costly, and hydrogen peroxide creates risk during transport. A hydrogen peroxide solution having a mass concentration of 1%-3% is commonly used in clinical medicine, for effective disinfection, or in domestic wastewater treatment.

### SUMMARY

The disclosure provides a gas diffusion electrode, a hydrogen peroxide production device comprising the same, and uses thereof; the hydrogen peroxide production device comprises a plurality of hydrogen peroxide production units each comprising an anode, a cathode, and an insulating sleeve; the cathode is a tubular gas diffusion electrode; the anode comprises a titanium substrate coated with iridium dioxide; the insulating sleeve is disposed between the anode and the cathode; the gas diffusion electrode comprises a carbon fiber tube, which is easy to be nested in one another, thus improving oxygen mass transfer efficiency; and the number of the plurality of hydrogen peroxide production units is selected as needed. The hydrogen peroxide production device is used in conjunction with an electro-Fenton reactor to achieve an in-situ production of hydrogen peroxide.

The gas diffusion electrode comprises a carbon fiber tube, a support layer, and a catalyst layer; the carbon fiber tube is straight and functions as a substrate; the support layer comprises a carbon black-polytetrafluoroethylene (PTFE) coating, and is disposed on the substrate; the catalyst layer comprises carbon black, anhydrous ethanol, and PTFE, and is disposed on the support layer; the carbon black-polytetrafluoroethylene (PTFE) coating is able to reduce static electricity and used as a catalyst to promote two-electron oxygen reduction, while maintaining conductivity; as a result, the catalyst is attached on the surface of the gas diffusion electrode; and the shape of the carbon fiber tube allows easy connection and improves oxygen mass transfer efficiency.

In a class of this embodiment, the gas diffusion electrode is U-shaped or tubular; and the tubular gas diffusion electrode facilitates the connection of electric circuits or gas channels.

In a class of this embodiment, the gas diffusion electrode has a diameter of 3-20 mm and a length of 50-500 mm.

A method for preparing the gas diffusion electrode, comprises:

S1. weaving 100-400 carbon fiber filaments into a strand of carbon fiber; weaving 20-30 strands of carbon fiber into a carbon fiber tube; ultrasonically vibrating the carbon fiber tube in an acetone solution, and washing the carbon fiber tube with ultrapure water;

S2. mixing carbon black and a polytetrafluoroethylene solution at a weight ratio to form a first mixture; and disposing a coating of the first mixture on the surface of the carbon fiber tube; the coating is able to reduce static electricity and used as a catalyst to promote two-electron oxygen reduction, while maintaining conductivity; and the catalyst is attached on the carbon fiber tube;

S3. placing the carbon fiber tube obtained in S2 in a muffle furnace at 300-400° C. for 20-40 min; and

S4. mixing carbon black, anhydrous ethanol, and PTFE to form a second mixture; depositing the second mixture on the surface of the carbon fiber tube obtained in S3 to form a catalyst layer; and placing the carbon fiber tube having the catalyst layer in the muffle furnace at 300° C.-400° C. for 20-40 min.

The gas diffusion electrode is U-shaped and tubular, which facilitates the connection of electric circuits or gas channels.

In a class of this embodiment, in S2, a weight ratio of carbon black to PTFE is between 1:40 and 10:40.

In a class of this embodiment, repeating S3 two or three times and performing S4 to increase catalytic efficiency of the hydrogen peroxide production device.

The disclosure further provides a hydrogen peroxide production device comprising a plurality of hydrogen peroxide production units connected to each other; each hydrogen peroxide production unit comprises a cathode, an insulating sleeve, and an anode from inside to outside; the cathode employs the abovementioned gas diffusion electrode. The number of the plurality of hydrogen peroxide production units is selected as needed. Preferably, the number of the hydrogen peroxide production units is 5-20.

In a class of this embodiment, the anode is a titanium substrate coated with a metal oxide; the metal oxide includes, but is not limited to, an oxide of ruthenium, iridium, tantalum, or lead. Preferably, the anode is a titanium substrate comprising an iridium dioxide coating.

In a class of this embodiment, a distance between the anode and the cathode is 1-30 mm.

In a class of this embodiment, the insulating sleeve has a thickness of 1-30 mm, and comprises an organic silica, an organic plastic, or an inorganic ceramic material.

In a class of this embodiment, the plurality of hydrogen peroxide production units is welded to each other by a waterproof connector.

In a class of this embodiment, the hydrogen peroxide production device further comprises a power supply, an electro-Fenton reactor, an air compressor, a water pump, a tank, an air pipe, and a conduit; the plurality of hydrogen peroxide production units are connected to each other and disposed in the electro-Fenton reactor; the electro-Fenton reactor comprises a top part and a bottom part; a water inlet is disposed on the bottom part and an overflow outlet is disposed on the top part; one end of the air pipe is connected to the electro-Fenton reactor; another end of the air pipe is connected to the air compressor; one end of the water pump is connected to the water inlet; another end of the water pump is connected to the tank; and the tank is connected to the overflow outlet through the conduit. A solution is added to electro-Fenton reactor to cover the gas diffusion electrode; and the air compressor aerates the electro-Fenton reactor.

In a class of this embodiment, the electro-Fenton reactor is in the shape of a cubic or cylindrical vessel.

In a class of this embodiment, the conduit is a silicone tube.

The disclosure also provides a method of preparing hydrogen peroxide using the hydrogen peroxide production device, the method comprising:

S1. turning on the air compressor to aerate the electro-Fenton reactor; turning on the water pump to pump a sodium sulfate solution into the electro-Fenton reactor until the sodium sulfate solution covers the plurality of hydrogen peroxide production units; controlling the current of the hydrogen peroxide production device, so that a solid, liquid and gas three-phase interface is formed on the catalyst layer of the gas diffusion electrode, to produce hydrogen peroxide; and

S2. recycling an effluent produced in S1 to the electro-Fenton reactor through a circulation process.

In a class of this embodiment, in S1, the hydrogen peroxide production device is operated at a current density of 10-200 mA/cm² and a voltage of 2.0-4.0 V; and the air compressor offers an air flow rate of 10-150 L/min.

In a class of this embodiment, in S1, the concentration of the sodium sulfate solution is 0.05-0.15 M.

A method for wastewater treatment using the hydrogen peroxide production device, comprises:

S1. turning on the air compressor to aerate the electro-Fenton reactor; preparing a wastewater sample containing an organic pollutant, sodium sulfate anhydrous, and Fe²⁺; turning on the water pump to pump the wastewater sample into the electro-Fenton reactor until the wastewater sample covers the plurality of hydrogen peroxide production units; controlling the current of the hydrogen peroxide production device, so that a solid, liquid and gas three-phase interface is formed on the catalyst layer of the gas diffusion electrode, to produce hydrogen peroxide;

S2. generating hydroxyl radicals from hydrogen peroxide to mineralize the organic pollutant; and discharging an effluent into the tank via the overflow outlet; and

S3. recycling the effluent produced in 2) to the electro-Fenton reactor through a circulation process.

In a class of this embodiment, in S1, the hydrogen peroxide production device is operated at a current density of 10-200 mA/cm² and a voltage of 2.0-4.0 V; and the air compressor offers an air flow rate of 10-150 L/min.

In a class of this embodiment, in S1, the wastewater sample has a pH of 3.0-7.0.

In a class of this embodiment, in S1, the sodium sulfate anhydrous is diluted to a concentration of 0.05-0.15 M.

The following advantages are associated with the hydrogen peroxide production device of the disclosure:

(1) compared to a conventional plate-shaped or sheet-shaped gas diffusion electrode, a tubular gas diffusion electrode maximizes oxygen mass transfer efficiency, improves space utilization rate, and maintains the performance of the cathode; the electro-Fenton reactor is aerated through a pipeline, instead of by an aerator head, so as to maximize oxygen mass transfer efficiency and increases current efficiency; the tubular shape is allows easy connection; and the number of the plurality of hydrogen peroxide production units is selected as needed;

(2) the hydrogen peroxide production device balances the oxygen mass transfer efficiency and the current efficiency, and reduces side-reactions caused by a turbulence in the solution, to produce hydrogen peroxide and facilitating the degradation of the organic pollutant to be removed; the produced hydrogen peroxide reaches a concentration of 400-1000 mg/L, which is suitable for large-scale production; and

(3) the hydrogen peroxide production device is used in conjunction with the electron-Fenton reactor to achieve a pollutant removal rate of greater than 95% and the pH in the device is 2.0-7.0.

### DETAILED DESCRIPTION OF THE DRAWINGS

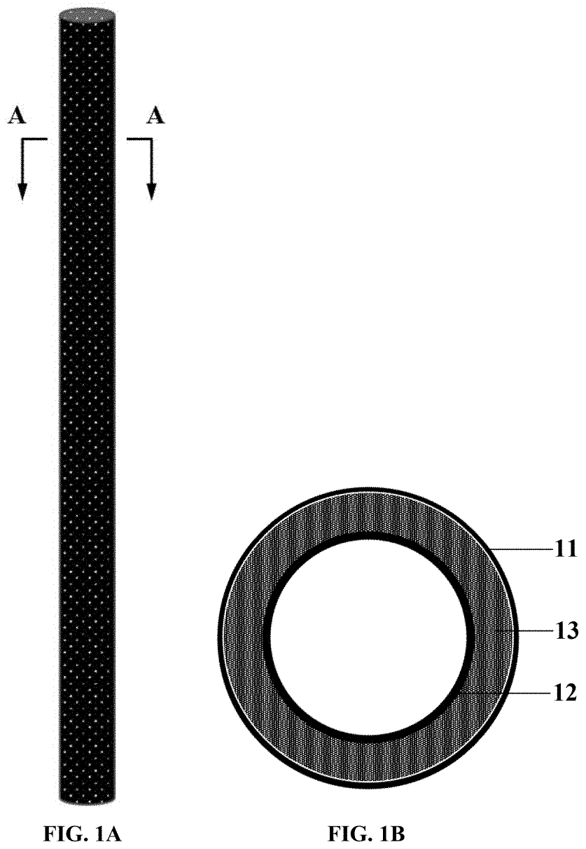

FIG. 1A is a front view of a hydrogen peroxide production unit according to one example of the disclosure; FIG. 1B is a sectional view taken from line A-A in FIG. 1A;

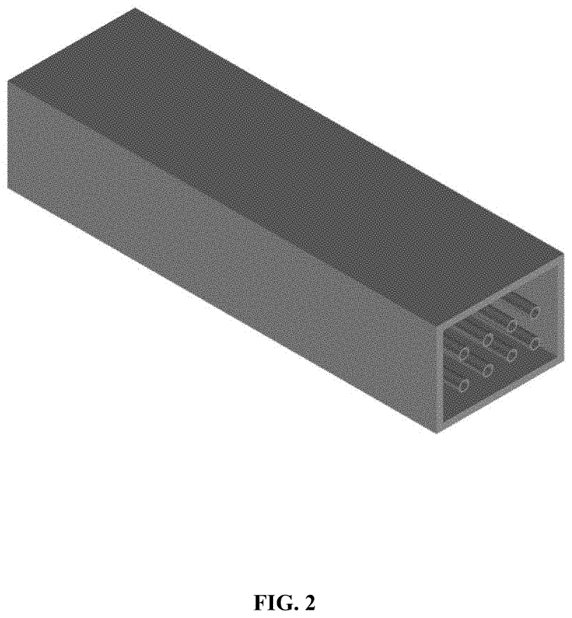

FIG. 2 is a perspective view of a plurality of hydrogen peroxide production units used in conjunction with a cuboid electron-Fenton reactor according to one example of the disclosure;

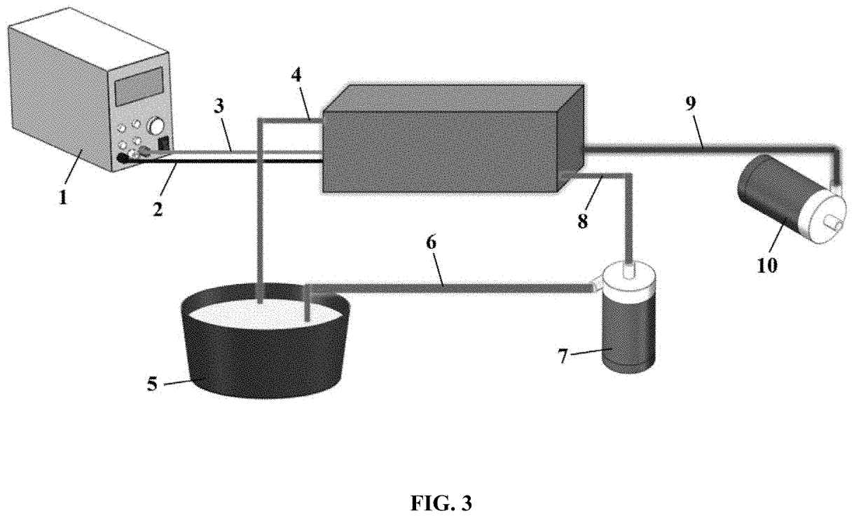

FIG. 3 is a perspective view of a hydrogen peroxide production device according to one example of the disclosure;

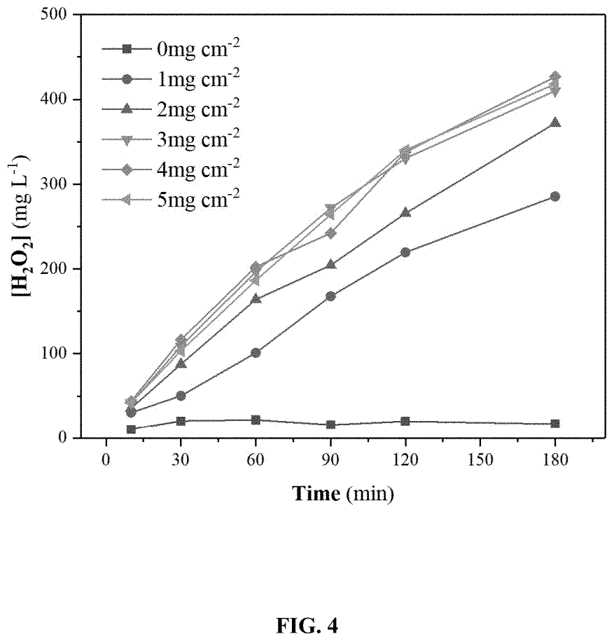

FIG. 4 is a graph showing a production volume of hydrogen peroxide versus time for different amounts of a catalyst;

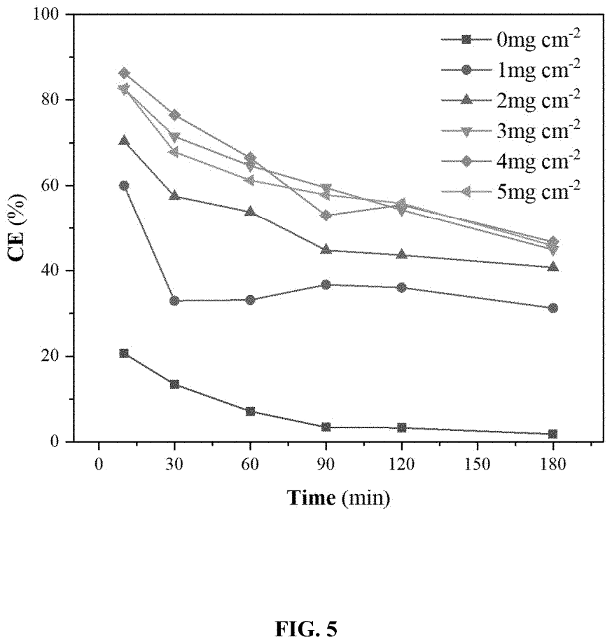

FIG. 5 is a graph showing current efficiency versus time for different amounts of catalyst;

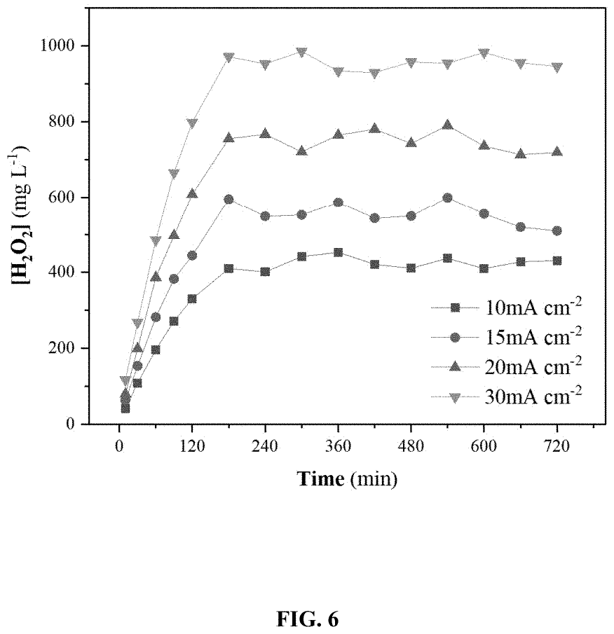

FIG. 6 is a graph showing a production volume of hydrogen peroxide versus time for different current densities; and

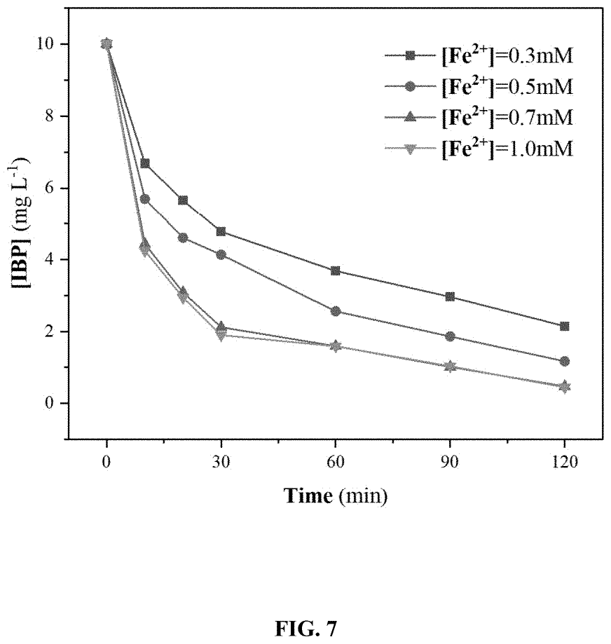

FIG. 7 is a graph showing the concentration of Ibuprofen versus time for different concentrations of Fe²⁺.

In the drawings, the following reference numbers are used: 1. Power supply; 2. Cathode lead; 3. Anode lead; 4. Overflow outlet; 5. Tank; 6. Inlet pipe; 7. Water pump; 8. Water inlet; 9. Air pipe; 10. Air compressor; 11. Anode; 12. Cathode; and 13. Insulating sleeve.

### DETAILED DESCRIPTION

Unspecified reaction conditions follow conventional conditions or manufacturer's recommendations. Reagents or instruments that do not specify the manufacturer or preparation method are conventional products that can be purchased from the market.

As used herein, the term “approximately,” as applied to one or more values of interest, refers to a value that is similar to a stated reference value. Throughout this application, various examples of this disclosure may be presented in a range format. It should be understood that the description in range format is merely for convenience and brevity and should not be construed as an inflexible limitation on the scope of the invention.

The term “at least one” as used herein refers to one or more. For example, the term “at least one of A, B, and C” refers to A, B, C, or a combination thereof.

Accordingly, the description of a range should be considered to have specifically disclosed all the possible subranges as well as individual numerical values within that range. For example, description of a range such as from 1 to 3 should be considered to have specifically disclosed subranges such as from 1 to 3, from 2 to 4 etc., as well as individual numbers within that range, for example, 2 3, and 4. The same principle applies to ranges defined by only one numerical value, such as “less than or equal to about 4.5.

It is to be understood that such corresponding descriptions are not limited by the order of the steps, as some steps may occur in different orders and/or concurrently with other steps from what is depicted and described herein.

### Example 1

The example provides a gas diffusion electrode and a preparation method thereof.

As shown in FIG. 1, the gas diffusion electrode was in the shape of a tube having a diameter of 8 mm and a length of 500 mm. The gas diffusion electrode comprised a carbon fiber tube, a support layer, and a catalyst layer; the carbon fiber tube was used as a substrate; the support layer comprised a coating comprising carbon black and PTFE, and was formed on the carbon fiber tube; the catalyst layer comprised carbon black, anhydrous ethanol, and PTFE, and was disposed on the support layer; the coating was used to reduce static electricity and used as a catalyst to promote two-electron oxygen reduction, while maintaining conductivity; as a result, the catalyst was attached on the surface of the gas diffusion electrode; and the shape of the carbon fiber tube allowed easy connection and improved oxygen mass transfer efficiency.

The preparation method of the gas diffusion electrode is detailed as follows:

S1. 100-400 carbon fiber filaments were woven into a strand of carbon fiber; 20-30 strands of carbon fiber were woven into a carbon fiber tube; the carbon fiber tube was ultrasonically vibrated in an acetone solution and washed with ultrapure water;

S2. carbon black and a polytetrafluoroethylene (PTFE) solution were mixed at a weight ratio of between 1:40 and 10:40 to form a first mixture; and a coating of the first mixture was formed on the surface of the carbon fiber tube; the coating was used to reduce static electricity and used as a catalyst to promote two-electron oxygen reduction, while maintaining conductivity; as a result, the catalyst was attached on the carbon fiber tube;

S3. the carbon fiber tube was placed in a muffle furnace at 300-400° C. for 20-40 min; and S3 was repeated 2-3 times; and

S4. carbon black, anhydrous ethanol, and PTFE were mixed to form a second mixture; a layer of the second mixture as a catalyst layer was formed on the surface of the carbon fiber tube obtained in S3; and the carbon fiber tube was placed in the muffle furnace at 300-400° C. for 20-40 min.

### Example 2

The example provides a hydrogen peroxide production unit.

As shown in FIG. 1, the hydrogen peroxide production unit comprised an anode 11, a cathode 12, and an insulating sleeve 13; the anode comprised a titanium substrate comprising a metal oxide coating; the cathode 12 was the gas diffusion electrode in Example 1; and the insulating sleeve 13 had a thickness of 10 mm and was disposed between the anode 11 and the cathode 12. The anode 11 and cathode 12 were coaxially connected to the insulating sleeve 13 thus improving the oxygen mass transfer efficiency.

### Example 3

The example provides a hydrogen peroxide production device and a use thereof.

As shown in FIG. 3, the hydrogen peroxide production device comprised an electro-Fenton reactor, a power supply 1, a cathode lead 2, an anode lead 3, an overflow outlet 4, a tank 5, a water inlet pipe 6, a water pump 7, a water inlet 8, an air pipe 9, and an air compressor 10; the water inlet pipe 6 was disposed between the tank 5 and the water pump 7; one end of the air pipe 9 was connected to the electro-Fenton reactor; another end of the air pipe 9 was connected to the air compressor 10; one end of the water pump 7 was connected to the water inlet 8; another end of the water pump 7 was connected to the tank 5; and the tank 5 was connected to the overflow outlet 4 through a conduit. As shown in FIG. 2, the electro-Fenton reactor comprised a cuboid structure comprising eight hydrogen peroxide production units prepared in Example 2.

In use, 0.05-0.15 M sodium sulfate solution was added to the tank 5; the water pump 7 was turned on and pumped the sodium sulfate solution from the tank 5 to the electro-Fenton reactor through the water inlet 8, until the eight hydrogen peroxide production units were submerged in the sodium sulfate solution; the air compressor 10 was turned on and aerated the electro-Fenton reactor at an air flow rate of 10-150 L/min; a current density was 10-200 mA/cm² and a voltage was 2.0-4.0 V; as a result, the water formed a solid, liquid and gas three-phase interface on the gas diffusion electrode, to produce hydrogen peroxide; an effluent produced in the electro-Fenton reactor flowed into the tank 5 through the overflow outlet 4 and was treated by a circulating process.

### Example 4

In the example, the hydrogen peroxide production device was operated at different amounts of catalyst. The hydrogen peroxide production device was as shown in FIG. 3 and operated under the conditions: 0.05 M sodium sulfate solution (Na₂SO₄), pH=7, a current density of 10 mA/cm², and an air flow rate of 32 L/min.

S1. 0.2 L of sodium sulfate solution was added to the tank; and the water pump was turned on; and

S2. the eight hydrogen peroxide production units were submerged in the sodium sulfate solution; the air compressor and the power supply were turned on; and a constant current density was 10 mA/cm². In use, a distance between the anode and cathode in the electro-Fenton reactor was 10 mm; the oxygen in the air entered the electro-Fenton reactor through the air pump; and a solid, liquid and gas three-phase interface was formed on the surface of the gas diffusion cathode to increase oxygen mass transfer efficiency; the oxygen undergone two-electron oxygen reduction in the present of catalyst to form hydrogen peroxide. After repeated producing hydrogen peroxide, the solution in the tank is sampled for measurement of the concentration of hydrogen peroxide.

FIG. 4 is a graph showing a production volume of hydrogen peroxide versus time for different amounts of catalyst. FIG. 5 is a graph showing current efficiency versus time for different amounts of catalyst. The hydrogen peroxide volume reached 450 mg/L after the reaction proceeded for 3 hours.

### Example 5

In the example, hydrogen peroxide production device was operated at different current densities. The hydrogen peroxide production device is shown in FIG. 3 and run under the conditions: 0.05 M Na₂SO₄, pH=7, a current density of 10-30 mA/cm², and an air flow rate of 32 L/min.

S1. 0.2 L of sodium sulfate solution was added to the tank; and the water pump was turned on; and

S2. the eight hydrogen peroxide production units were submerged in the sodium sulfate solution; the air compressor and the power supply were turned on; and a constant current density was 10, 15, 20, and 30 mA/cm². In use, a distance between the anode and cathode in the electro-Fenton reactor was 10 mm; the oxygen in the air entered the electro-Fenton reactor through the air pump; and a solid, liquid and gas three-phase interface was formed on the surface of the gas diffusion cathode to increase oxygen mass transfer efficiency; the oxygen undergone two-electron oxygen reduction in the present of catalyst to form hydrogen peroxide. After repeated producing hydrogen peroxide, the solution in the tank was sampled for determination of the concentration of hydrogen peroxide. The hydrogen peroxide volume reached 1000 mg/L after the reaction proceeded for 3 hours. The hydrogen peroxide production device was switched to a continuous flow mode that lasts for three hours. FIG. 6 is a graph showing a production volume of hydrogen peroxide versus time for different current densities.

### Example 6

In the example, ibuprofen (IBP)-containing wastewater was treated by the hydrogen peroxide production device as shown in FIG. 3. The hydrogen peroxide production device was operated under the conditions: 10 mg/L IBP; 0.05 M Na₂SO₄; 0.3-1.0 M Fe²⁺; a current density of 10 mA/cm²; and an air flow rate of 32 L/min.

S1. The IBP-containing wastewater was prepared and added to the tank; the water pump and the air compressor was turned on;

S2. when the IBP-containing wastewater became turbulent, the power supply was turned on; and the hydrogen peroxide production device was operated at a constant current density of 10 mA/cm²; and

S3. the solution in the tank was sampled at regular intervals for determination of the concentration of IBP.

FIG. 7 is a graph showing concentration of ibuprofen versus time for different concentrations of Fe²⁺. The results show that a degradation efficiency of ibuprofen was 99.13%.

It will be obvious to those skilled in the art that changes and modifications may be made, and therefore, the aim in the appended claims is to cover all such changes and modifications.

The invention claimed is:

1. A gas diffusion electrode, comprising a carbon fiber tube, a support layer, and a catalyst layer; wherein the carbon fiber tube is straight and functions as a substrate; the support layer comprises a carbon black-polytetrafluoroethylene (PTFE) coating, and is disposed on the substrate; the catalyst layer comprises carbon black, anhydrous ethanol, and PTFE, and is disposed on the support layer; and the gas diffusion electrode has a diameter of 3-20 mm and a length of 50-500 mm.

2. A hydrogen peroxide production device, comprising a plurality of hydrogen peroxide production units connected to each other; wherein each hydrogen peroxide production unit comprises a cathode, an insulating sleeve, and an anode from inside to outside; and the cathode is the gas diffusion electrode of claim 1.

3. The device of claim 2, wherein the anode is a titanium substrate comprising an iridium dioxide coating.

4. The device of claim 3, wherein a distance between the anode and the cathode is 1-30 mm.

5. The device of claim 4, wherein the insulating sleeve has a thickness of 1-30 mm, and comprises an organic silica, an organic plastic, or an inorganic ceramic material.

6. The device of claim 2, further comprising a power supply, an electro-Fenton reactor, an air compressor, a water pump, a tank, an air pipe, and a conduit; wherein the plurality of hydrogen peroxide production units are connected to each other and disposed in the electro-Fenton reactor; the electro-Fenton reactor comprises a top part and a bottom part; a water inlet is disposed on the bottom part and an overflow outlet is disposed on the top part; one end of the air pipe is connected to the electro-Fenton reactor; another end of the air pipe is connected to the air compressor; one end of the water pump is connected to the water inlet; another end of the water pump is connected to the tank; and the tank is connected to the overflow outlet through the conduit.

7. A method of preparing hydrogen peroxide using the hydrogen peroxide production device of claim 6, the method comprising: turning on the air compressor to aerate the electro-Fenton reactor; turning on the water pump to pump a sodium sulfate solution into the electro-Fenton reactor until the sodium sulfate solution covers the plurality of hydrogen peroxide production units; controlling the current of the hydrogen peroxide production device, so that a solid, liquid and gas three-phase interface is formed on the catalyst layer of the gas diffusion electrode, to produce hydrogen peroxide.

8. The method of claim 7, wherein the hydrogen peroxide production device is operated at a current density of 10-200 mA/cm² and a voltage of 2.0-4.0 V; and the air compressor offers an air flow rate of 10-150 L/min.

9. The method of claim 8, wherein a concentration of the sodium sulfate solution is 0.05-0.15 M.

10. A method for wastewater treatment using the hydrogen peroxide production device of claim 6, the method comprising:
1) turning on the air compressor to aerate the electro-Fenton reactor; preparing a wastewater sample containing an organic pollutant, sodium sulfate anhydrous, and Fe²⁺; turning on the water pump to pump the wastewater sample into the electro-Fenton reactor until the wastewater sample covers the plurality of hydrogen peroxide production units; controlling the current of the hydrogen peroxide production device, so that a solid, liquid and gas three-phase interface is formed on the catalyst layer of the gas diffusion electrode, to produce hydrogen peroxide;
2) generating hydroxyl radicals from hydrogen peroxide to mineralize the organic pollutant; and discharging an effluent into the tank via the overflow outlet; and
3) recycling the effluent produced in 2) to the electro-Fenton reactor through a circulation process.

11. The method of claim 10, wherein in 1), the hydrogen peroxide production device is operated at a current density of 10-200 mA/cm² and a voltage of 2.0-4.0 V; and the air compressor offers an air flow rate of 10-150 L/min.
